(19) United States
(12) Patent Application Publication
(10) Pub. No.: US 2013/0241800 A1
(43) Pub. Date: Sep. 19, 2013

(54) Electronic Device with Tunable and Fixed Antennas

(71) Applicants: Robert W. Schlub, Cupertino, CA (US); Rodney A. Gomez Angulo, Sunnyvale, CA (US); Qingxiang Li, Mountain View, CA (US); Emily B. McMilin, Mountain View, CA (US); Salih Yarga, Sunnyvale, CA (US); Yi Jiang, Sunnyvale, CA (US)

(72) Inventors: Robert W. Schlub, Cupertino, CA (US); Rodney A. Gomez Angulo, Sunnyvale, CA (US); Qingxiang Li, Mountain View, CA (US); Emily B. McMilin, Mountain View, CA (US); Salih Yarga, Sunnyvale, CA (US); Yi Jiang, Sunnyvale, CA (US)

(21) Appl. No.: 13/420,278

(22) Filed: Mar. 14, 2012

(51) Int. Cl. H01Q 21/00

(52) U.S. Cl. 343/893

(57) ABSTRACT

Electronic devices may be provided that contain wireless communications circuitry. The wireless communications circuitry may include radio-frequency transceiver circuitry and antennas. The antennas may include a non-tunable antenna and a tunable antenna. The non-tunable antenna may serve as the primary antenna in the electronic device and the tunable antenna may serve as a secondary antenna in the electronic device. The non-tunable antenna may be configured to operate in at least one communications band. The tunable antenna may contain adjustable circuitry. The adjustable circuitry may be used to tune the tunable antenna to cover the same communications band used by the non-tunable antenna. The tunable antenna may have a resonating element and an antenna ground. The adjustable circuit may be coupled between the resonating element and the antenna ground. The adjustable circuit may include electrical components such as inductors and capacitors and a radio-frequency switch for antenna tuning.

### BACKGROUND

This relates generally to electronic devices, and more particularly, to antennas for electronic devices.

Electronic devices such as portable computers and cellular telephones are often provided with wireless communications capabilities. For example, electronic devices may use long-range wireless communications circuitry such as cellular telephone circuitry to communicate using cellular telephone bands. Electronic devices may use short-range wireless communications circuitry such as wireless local area network communications circuitry to handle communications with nearby equipment. Electronic devices may also be provided with satellite navigation system receivers and other wireless circuitry.

To satisfy consumer demand for small form factor wireless devices, manufacturers are continually striving to implement wireless communications circuitry such as antenna components using compact structures. At the same time, it may be desirable to include conductive structures in an electronic device such as metal device housing components. Because conductive components can affect radio-frequency performance, care must be taken when incorporating antennas into an electronic device that includes conductive structures. For example, care must be taken to ensure that the antennas and wireless circuitry in a device are able to exhibit satisfactory performance over a range of operating frequencies without causing undesired interference.

It would therefore be desirable to be able to provide wireless electronic devices with improved antenna structures.

### SUMMARY

Electronic devices may be provided that contain wireless communications circuitry. The wireless communications circuitry may include radio-frequency transceiver circuitry and antennas. The antennas may include a non-tunable antenna and a tunable antenna.

The non-tunable antenna may serve as the primary antenna in the electronic device and the tunable antenna may serve as a secondary antenna in the electronic device. The non-tunable antenna may be configured to operate in at least one communications band. The tunable antenna may contain adjustable circuitry. The adjustable circuitry may be used to tune the tunable antenna to cover the same communications band used by the non-tunable antenna, even in configurations in which the tunable antenna has been implemented in a smaller volume within the electronic device than the non-tunable antenna.

The tunable antenna may have a resonating element and an antenna ground. The adjustable circuit may be coupled between the resonating element and the antenna ground. The adjustable circuit may include electrical components such as inductors and capacitors and a radio-frequency switch for antenna tuning.

The electronic device may have a metal housing from which a common antenna ground is formed for the tunable and non-tunable antennas. A dielectric antenna window may be provided in the metal housing that overlaps the tunable and non-tunable antennas.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with wireless communications circuitry in accordance with an embodiment of the present invention.

FIG. 2 is a schematic diagram of an illustrative electronic device with wireless communications circuitry in accordance with an embodiment of the present invention.

FIG. 3 is a diagram of an illustrative array of antennas that may be used in wireless electronic devices of the type shown in FIGS. 1 and 2 in accordance with an embodiment of the present invention.

FIG. 4 is a diagram of an illustrative fixed (non-tunable) antenna that may be used in an antenna array in wireless communications circuitry in accordance with an embodiment of the present invention.

FIG. 5 is a diagram of an illustrative tunable antenna that may be used in an antenna array in wireless communications circuitry in accordance with an embodiment of the present invention.

FIG. 6 is a diagram of an illustrative switch-based tunable capacitor that may be used a tunable antenna in accordance with an embodiment of the present invention.

FIG. 7 is a diagram of an illustrative switch-based bypassable inductor that may be used in a tunable antenna in accordance with an embodiment of the present invention.

FIG. 8 is a diagram of an illustrative switch-based bypassable capacitor that may be used in a tunable antenna in accordance with an embodiment of the present invention.

FIG. 9 is a diagram of an illustrative tunable capacitor that may be used in a tunable antenna in accordance with an embodiment of the present invention.

FIG. 10 is an antenna performance graph showing how a non-tunable antenna may have a resonance peak that covers a communications band of interest and how a tunable antenna may be tuned so that its narrower resonance peak can cover the same communications band of interest in accordance with an embodiment of the present invention.

FIG. 11 is a top view of a portion of an electronic device in which first and second antennas have been implemented using antenna resonating elements of different sizes in accordance with an embodiment of the present invention.

FIG. 12 is a diagram showing how a switchless antenna may be used for transmitting and receiving wireless signals while a tunable antenna that contains an adjustable component such as a switch-based adjustable component may be used only in receiving wireless signals in accordance with an embodiment of the present invention.

FIG. 13 is a diagram showing how a switchless antenna may be used for transmitting wireless signals at a first maximum power while an antenna that contains an adjustable component such as a switch-based adjustable component may be used in transmitting wireless signals at a second power that is lower than the first maximum power in accordance with an embodiment of the present invention.

### DETAILED DESCRIPTION

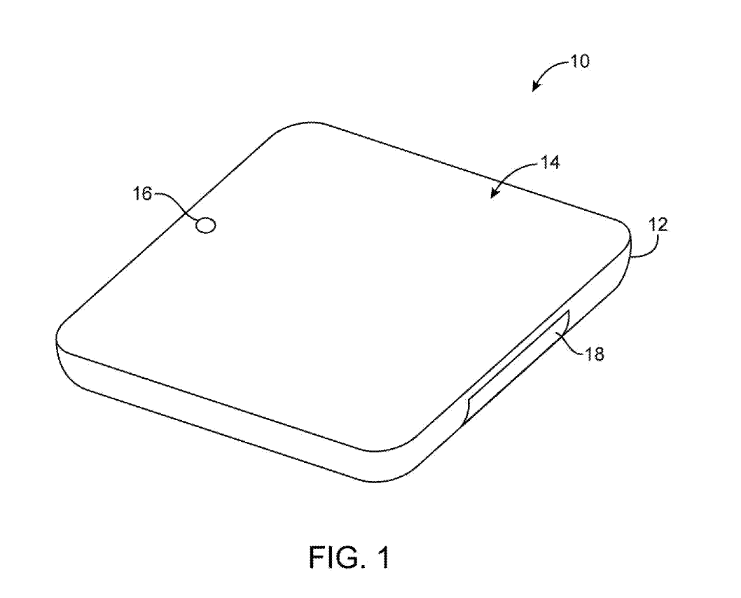

Electronic devices such as electronic device 10 of FIG. 1 may be provided with wireless communications circuitry. The wireless communications circuitry may be used to support wireless communications in multiple wireless communications bands. The wireless communications circuitry may include multiple antennas.

The antennas can include loop antennas, inverted-F antennas, strip antennas, planar inverted-F antennas, slot antennas, hybrid antennas that include antenna structures of more than one type, or other suitable antennas. Conductive structures for the antennas may, if desired, be formed from conductive electronic device structures. The conductive electronic device structures may include conductive housing structures. The housing structures may include a peripheral conductive member that runs around the periphery of an electronic device. The peripheral conductive member may serve as a bezel for a planar structure such as a display, may serve as sidewall structures for a device housing, and/or may form other housing structures. Gaps in the peripheral conductive member may be associated with the antennas.

The antennas may, if desired, be formed from patterned metal foil or other metal structures or may be formed from conductive traces such as metal traces on a substrate. The substrate may be a plastic structure or other dielectric structure, a rigid printed circuit board substrate such as a fiberglass-filled epoxy substrate (e.g., FR4), a flexible printed circuit (“flex circuit”) formed from a sheet of polyimide or other flexible polymer, or other substrate material. The housing for electronic device 10 may be formed from conductive structures (e.g., metal) or may be formed from dielectric structures (e.g., glass, plastic, ceramic, etc.). Antenna windows formed from plastic or other dielectric material may, if desired, be formed in conductive housing structures. Antennas for device 10 may be mounted so that the antenna window structures overlap the antennas. During operation, radio-frequency antenna signals may pass through the dielectric antenna windows and other dielectric structures in device 10.

Electronic device 10 may be a portable electronic device or other suitable electronic device. For example, electronic device 10 may be a laptop computer, a tablet computer, a somewhat smaller device such as a wrist-watch device, pendant device, headphone device, earpiece device, or other wearable or miniature device, a cellular telephone, or a media player. Device 10 may also be a television, a set-top box, a desktop computer, a computer monitor into which a computer has been integrated, or other suitable electronic equipment.

Device 10 may have a display such as display 14 that is mounted in a housing such as housing 12. Display 14 may, for example, be a touch screen that incorporates capacitive touch electrodes. Display 14 may include image pixels formed from light-emitting diodes (LEDs), organic LEDs (OLEDs), plasma cells, electrowetting pixels, electrophoretic pixels, liquid crystal display (LCD) components, or other suitable image pixel structures. A cover glass layer may cover the surface of display 14. The cover glass may have one or more openings such as an opening to accommodate button 16.

Housing 12, which may sometimes be referred to as a case, may be formed of plastic, glass, ceramics, fiber composites, metal (e.g., stainless steel, aluminum, etc.), other suitable materials, or a combination of these materials. In some situations, housing or parts of housing 12 may be formed from dielectric or other low-conductivity material. In other situations, housing 12 or at least some of the structures that make up housing 12 may be formed from metal elements. In configurations for device 10 in which housing 12 is formed from conductive materials such as metal, one or more dielectric antenna windows such as antenna window 18 of FIG. 1 may be formed in housing 12.

Antenna window 18 may be formed from a dielectric such as plastic (as an example). Antennas in device 10 may be mounted within housing 12 so that antenna window 18 overlaps the antennas. During operation, radio-frequency antenna signals can pass through antenna window 18 and other dielectric structures in device 10 (e.g., edge portions of the cover glass for display 14).

Device 10 may have two or more antennas. The antennas may be used to implement an antenna array in which signals for multiple identical data streams (e.g., Code Division Multiple Access data streams) are combined to improve signal quality or may be used to implement a multiple-input-multiple-output (MIMO) antenna scheme that enhances performance by handling multiple independent data streams (e.g., independent Long Term Evolution data streams). Multiple antennas may be used together in both transmit and receive modes of operation or may only be used together during signal reception operations.

Antennas in device 10 may be used to support any communications bands of interest. For example, device 10 may include antenna structures for supporting local area network communications, voice and data cellular telephone communications, global positioning system (GPS) communications or other satellite navigation system communications, Bluetooth® communications, etc.

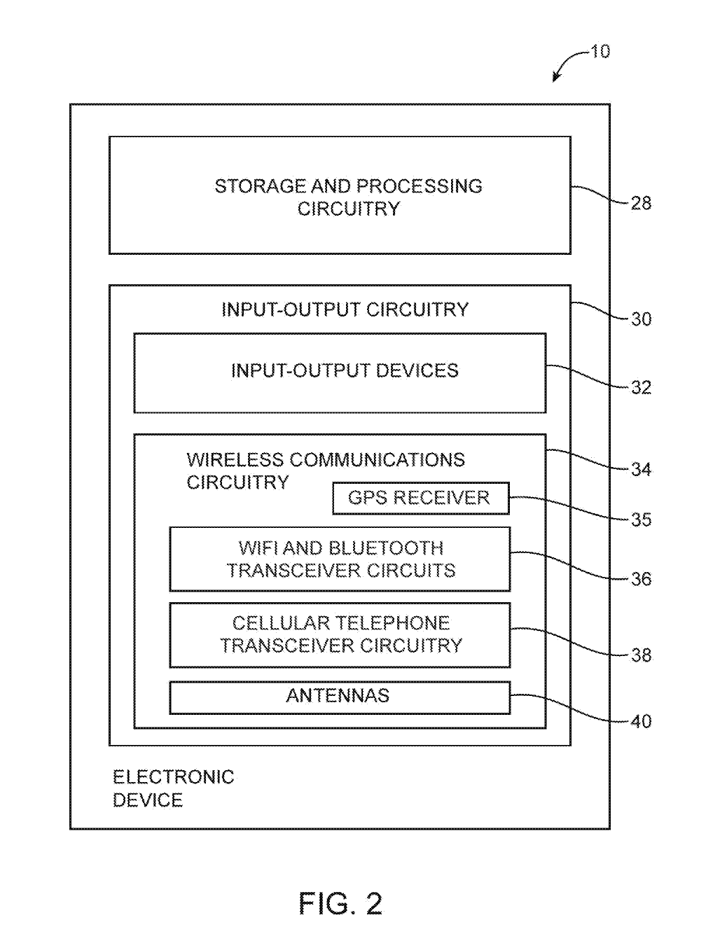

A schematic diagram of an illustrative configuration that may be used for electronic device 10 is shown in FIG. 2. As shown in FIG. 2, electronic device 10 may include control circuitry such as storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. The processing circuitry may be based on one or more microprocessors, microcontrollers, digital signal processors, baseband processors, power management units, audio codec chips, application specific integrated circuits, etc.

Storage and processing circuitry 28 may be used to run software on device 10, such as internet browsing applications, voice-over-internet-protocol (VOIP) telephone call applications, email applications, media playback applications, operating system functions, etc. To support interactions with external equipment, storage and processing circuitry 28 may be used in implementing communications protocols. Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, cellular telephone protocols, etc.

Circuitry 28 may be configured to implement control algorithms that control the use of antennas in device 10. For example, circuitry 28 may perform signal quality monitoring operations, sensor monitoring operations, and other data gathering operations and may, in response to the gathered data and information on which communications bands are to be used in device 10, control which antenna structures within device 10 are being used to receive and process data and/or may adjust one or more switches, tunable elements, or other adjustable circuits in device 10 to adjust antenna performance. As an example, circuitry 28 may control which of two or more antennas is being used to receive incoming radio-frequency signals, may control which of two or more antennas is being used to transmit radio-frequency signals, may control the process of routing incoming data streams over two or more antennas in device 10 in parallel, may tune an antenna to cover a desired communications band, etc. In performing these control operations, circuitry 28 may open and close switches, may turn on and off receivers and transmitters, may adjust impedance matching circuits, may configure switches in front-end-module (FEM) radio-frequency circuits that are interposed between radio-frequency transceiver circuitry and antenna structures (e.g., filtering and switching circuits used for impedance matching and signal routing), may adjust switches, tunable circuits, and other adjustable circuit elements that are formed as part of an antenna or that are coupled to an antenna or a signal path associated with an antenna, and may otherwise control and adjust the components of device 10.

Input-output circuitry 30 may be used to allow data to be supplied to device 10 and to allow data to be provided from device 10 to external devices. Input-output circuitry 30 may include input-output devices 32. Input-output devices 32 may include touch screens, buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 32 and may receive status information and other output from device 10 using the output resources of input-output devices 32.

Wireless communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Wireless communications circuitry 34 may include satellite navigation system receiver circuitry such as Global Positioning System (GPS) receiver circuitry 35 (e.g., for receiving satellite positioning signals at 1575 MHz) or satellite navigation system receiver circuitry associated with other satellite navigation systems. Transceiver circuitry 36 may handle 2.4 GHz and 5 GHz bands for WiFi® (IEEE 802.11) communications and may handle the 2.4 GHz Bluetooth® communications band. Circuitry 34 may use cellular telephone transceiver circuitry 38 for handling wireless communications in cellular telephone bands such as bands in frequency ranges of about 700 MHz to about 2200 MHz or bands at higher or lower frequencies. Wireless communications circuitry 34 can include circuitry for other short-range and long-range wireless links if desired. For example, wireless communications circuitry 34 may include wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 34 may include antennas 40. Antennas 40 may be formed using any suitable types of antenna. For example, antennas 40 may include antennas with resonating elements that are formed from loop antenna structure, patch antenna structures, inverted-F antenna structures, closed and open slot antenna structures, planar inverted-F antenna structures, helical antenna structures, strip antennas, monopoles, dipoles, hybrids of these designs, etc. Different types of antennas may be used for different bands and combinations of bands. For example, one type of antenna may be used in forming a local wireless link antenna and another type of antenna may be used in forming a remote wireless link.

There is generally a tradeoff between antenna volume and antenna bandwidth. An antenna that is implemented in a constrained volume will tend to exhibit a smaller bandwidth than a comparable antenna that is implemented in a larger volume. One way to overcome the tendency of small-volume antennas to exhibit narrow bandwidths involves providing the antennas with adjustable components. An adjustable component can be used to place the antenna in different configurations to support different desired frequencies of operation. Using antenna tuning, the frequency coverage of a compact narrow-bandwidth antenna can be expanded to match that of a less compact wider-bandwidth antenna.

It is not, however, always acceptable to use adjustable components in antennas. For example, radio-frequency switches and other adjustable circuits may exhibit non-linear behavior that can lead to the creation of undesired intermodulation distortion (IMD). If care is not taken, out-of-band emissions may be created due to the presence of the adjustable circuit (e.g., due to harmonics resulting from non-linear behavior). Electrostatic discharge events can damage adjustable components such as switches, so the presence of adjustable components may lead to reliability issues in a device. The presence of digital control lines for routing control signals to an adjustable component may potentially disrupt antenna performance (e.g., by providing a pathway for interference). The potential for interference from other circuits operating in an electronic device may also be increased by the presence of an adjustable component.

These potential performance issues with the use of adjustable components in an antenna may be exacerbated by higher antenna signal powers. At the typically low powers associated with received over-the-air antenna signals, nonlinearities may be minimal. At some or all transmit powers of interest, however, issues with intermodulation distortion, out-of-band emissions requirements, and other types of interference may make antenna performance unacceptable.

Due to considerations such as these, there are tradeoffs associated with using switches and other adjustable devices in an antenna. The inclusion of the switches or other adjustable devices may make it possible for an antenna to be tuned across a desired range of frequencies while minimizing antenna volume. The inclusion of the switches or other adjustable devices may, however, limit the maximum power handling capability of a tunable antenna. In contrast, antennas without adjustable components (e.g., non-tunable antennas that are switchless) may be capable of handling antenna signals with larger powers. Fixed (non-tunable) antennas may, however, consume more space within an electronic device than tunable antennas that cover comparable operating frequencies.

To maximize overall device performance, antennas 40 may be provided with one or more tunable antennas and one or more fixed antennas. For example, in a two-antenna configuration, antennas 40 may include a fixed antenna and a tunable antenna. The fixed antenna and the tunable antenna may both be used to handle wireless signals in device 10. For example, the fixed antenna and the tunable antenna may both be used for receiving data streams in a multiple antenna array (e.g., in a MIMO scheme or in a scheme in which identical antenna signals from each of the antennas are combined to improve signal quality). When it is desired to transmit antenna signals, the signals may be transmitted using the fixed antenna. Because higher-power (transmitted) signals are routed through the fixed antenna, the tunable antenna will not be subjected to higher-power signals and will not exhibit undesired nonlinearities. Because the tunable antenna is included in the electronic device, device size may be minimized (i.e., the size of the tunable antenna may be made smaller than a comparable fixed antenna covering the same frequency bands).

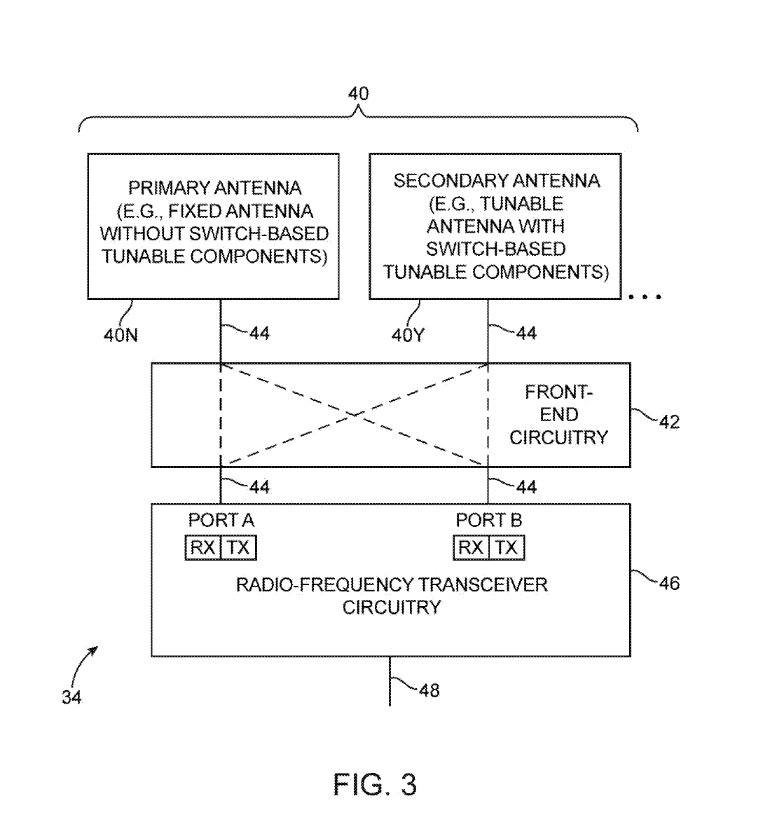

FIG. 3 is a diagram showing how antennas 40 may include multiple types of antenna. In the illustrative configuration of FIG. 3, antennas 40 include at least a first antenna of a first type such as antenna 40N and at least one second antenna of a second type such as antenna 40Y. Antenna 40N and 40Y may, for example, include different types and amounts of tunable circuit capabilities. With one suitable arrangement, which is sometimes described herein as an example, antenna 40N may be a fixed (non-tunable) antenna that is devoid of any antenna switching components, whereas antenna 40Y may be a tunable antenna that includes one or more adjustable components. In general, there may be any suitable number of antennas 40N (each of which may be identical or some or all of which may be different from each other) and any suitable number of antennas 40Y (each of which may be identical or some or all of which may be different from each other) among antennas 40 of device 10. Illustrative configurations in which antennas 40 include first antenna 40N and second antenna 40Y are sometimes described herein as an example.

Because antenna 40N does not contain any switch-based components or other potentially non-linear adjustable components (in this example), it may be desirable to use antenna 40N whenever device 10 is transmitting radio-frequency signals. Antenna 40Y contains one or more adjustable components (in this example) and may therefore most suitably be used for transmitting lower-power radio-frequency signals or be used exclusively for receiving radio-frequency signals. In this type of configuration, antenna 40N may be used to transmit and receive signals and may therefore sometimes be referred to as a primary antenna for device 10, whereas antenna 40Y may be used only in receiving signals (or in receiving signals and transmitting only lower power signals) and may therefore sometimes be referred to as a secondary antenna for device 10.

Antennas 40 may be coupled to radio-frequency transceiver circuitry 46 using signal paths 44 (e.g., transmission line paths) and front-end circuitry 42. Front-end circuitry 42 may include switches, transmission lines, filters, impedance matching circuits, amplifiers, and other circuitry. Radio-frequency transceiver circuitry 46 may operate in wireless local area network bands, satellite navigation bands, cellular telephone bands, and/or other communications bands of interest. One or more integrated circuits may be used in implementing radio-frequency transceiver circuitry 46.

Radio-frequency transceiver circuitry 46 may be supplied with data to be transmitted from a circuit such as a baseband processor using a path such as path 48. Antenna signals that have been received by radio-frequency transceiver circuitry 46 may be supplied to circuitry such as baseband processor circuitry using a path such as path 48.

Radio-frequency transceiver circuitry 46 may have multiple ports. For example, in a configuration in which antennas 40 include first antenna 40N and second antenna 40Y, radio-frequency transceiver circuitry 46 may include a first port (port A) and a second port (port B). Port A may include a receiver (RX) and a transmitter (TX). Port B may include a receiver (RX) and may or may not include a transmitter (TX). Front-end circuitry 42 may contain fixed pathways that couple antennas 40N and 40Y to ports A and B, respectively. If desired, front-end circuitry 42 may contain switching circuitry (e.g., a cross-bar switch) that allows antenna 40N to be coupled to either port A or port B while simultaneously coupling antenna 40Y to either port B or port A.

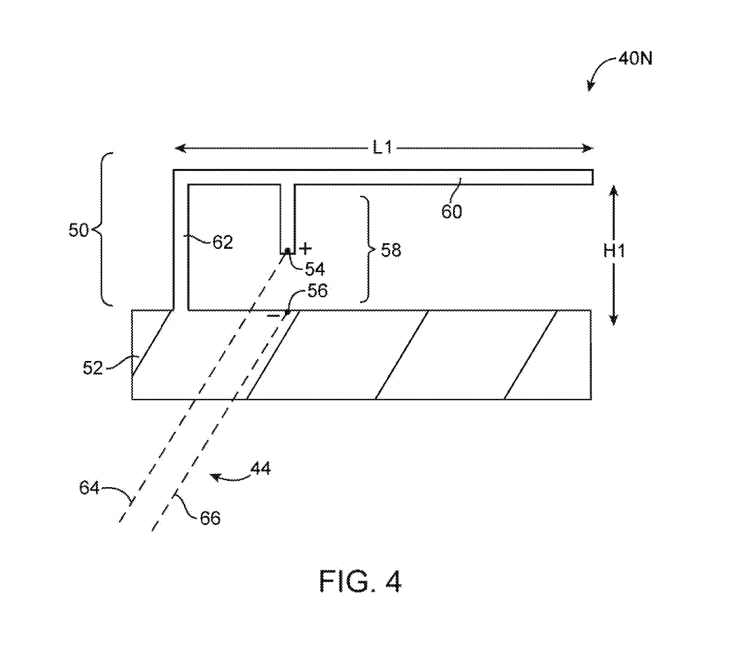

An illustrative configuration that may be used for antenna 40N is shown in FIG. 4. As shown in FIG. 4, antenna 40N may include conductive structures that form antenna resonating element 50 and antenna ground 52. Antenna resonating element 50 may, for example, be formed from patterned metal traces on a rigid or flexible printed circuit substrate or patterned metal traces on a molded plastic substrate (as examples). Antenna ground 52 may be formed from metal traces on a printed circuit, metal traces on a molded plastic substrate, and/or other conductive structures such as metal portions of housing 12. Antenna resonating element 50 in the example of FIG. 4 is an inverted-F antenna resonating element. This is merely illustrative. Antennas 40N may be based on any suitable type of antenna (e.g., a loop antenna, a strip antenna, a planar inverted-F antenna, a slot antenna, a hybrid antenna that includes antenna structures of more than one type, or other suitable antennas).

Antenna resonating element 50 may include a main resonating element arm such as arm 60. Short circuit branch 62 may be coupled between antenna resonating element arm 60 and antenna ground 52. Antenna 40N may have an antenna feed formed from feed terminals 54 and 56 in antenna feed branch 58. Antenna feed branch 58 may be coupled between arm 60 and ground 52. Signal path 44 may include positive path 64 and ground path 66. Positive path 64 may be coupled to positive antenna feed terminal 54. Ground signal path 66 may be coupled to ground antenna feed terminal 56. If desired, antenna 40N may include matching circuits, additional conductive structures, etc. Antenna 40N of FIG. 4 is switchless and does not contain potentially non-linear components such as radio-frequency switches (e.g., switches implemented from transistor circuitry on an integrated circuit).

Antenna 40N may have any suitable size and shape. In the illustrative example of FIG. 4, antenna 40N has a length L1 (e.g., a first lateral dimension associated with the length of main resonating element arm 60) and a height H1 (e.g., an orthogonal second lateral dimension associated with the length of short circuit branch 62). The overall area of antenna 40N in the illustrative configuration of FIG. 4 (e.g., the area associated with antenna resonating element 50) is approximately equal to L1*H1. The volume occupied by antenna 40N may be L1*H1*T1, where T1 is the thickness of the antenna resonating element.

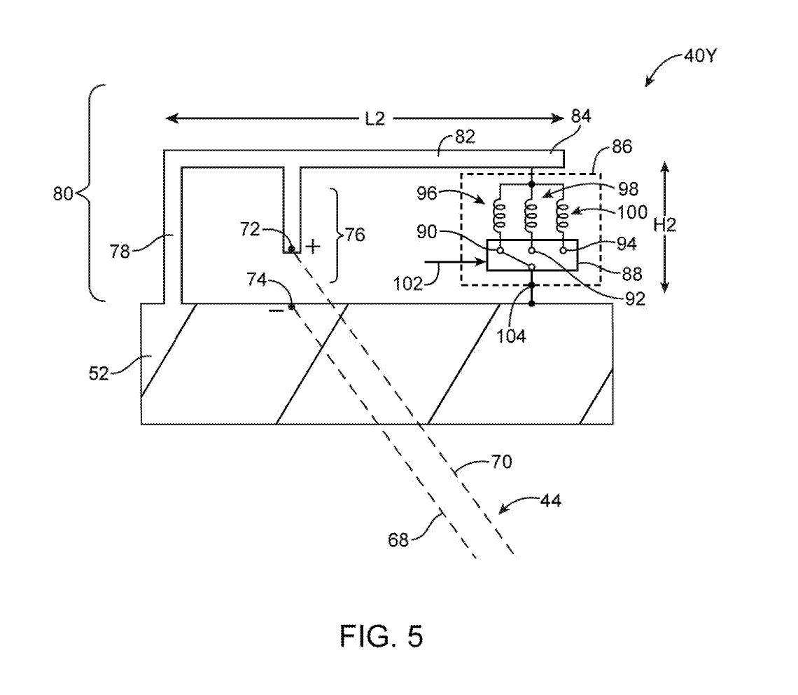

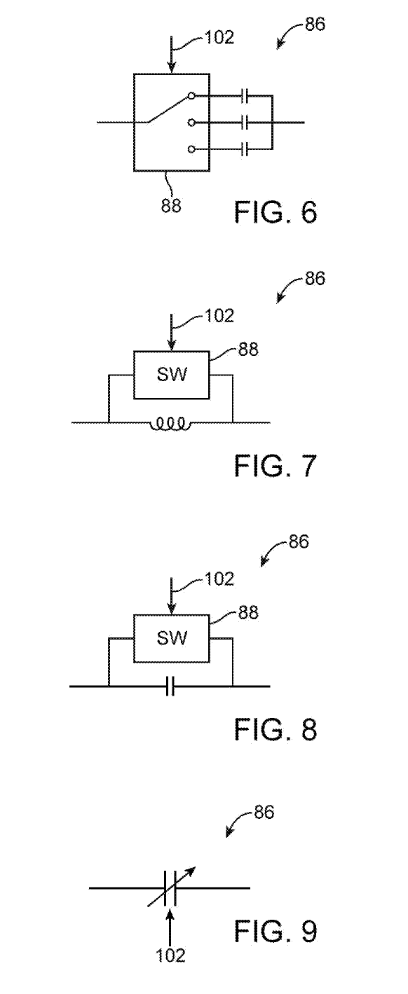

An illustrative configuration that may be used for antenna 40Y is shown in FIG. 5. As shown in FIG. 5, antenna 40Y may include conductive structures that form antenna resonating element 80 and antenna ground 52. As with antenna resonating element 50 of antenna 40N, antenna resonating element 80 may be formed from patterned metal traces on a rigid or flexible printed circuit substrate or patterned metal traces on a molded plastic substrate (as examples). Antenna ground 52 of antenna 40Y may be formed as part of the same conductive structures that form antenna ground 52 of antenna 40N or may be formed from other conductive structures. As an example, antenna ground 52 may be formed from metal traces on a printed circuit, metal traces on a molded plastic substrate, and/or other conductive structures such as metal portions of housing 12. Housing 12 may, for example, form a common antenna ground for both antennas 40N and 40Y.

Antenna resonating element 80 in the example of FIG. 5 is an inverted-F antenna resonating element. This is merely illustrative. Antennas 40Y may be based on any suitable type of antenna (e.g., a loop antenna, a strip antenna, a planar inverted-F antenna, a slot antenna, a hybrid antenna that includes antenna structures of more than one type, or other suitable antennas).

Antenna resonating element 80 may include a main resonating element arm such as arm 82. Short circuit branch 78 may be coupled between antenna resonating element arm 80 and antenna ground 52. Antenna 40Y may have an antenna feed formed from feed terminals 72 and 74 in antenna feed branch 76. Antenna feed branch 76 may be coupled between arm 82 and ground 52. Signal path 44 may include positive path 70 and ground path 68. Positive path 70 may be coupled to positive antenna feed terminal 72. Ground signal path 68 may be coupled to ground antenna feed terminal 74. If desired, antenna 40Y may include matching circuits, additional conductive structures, etc.

Antenna 40Y may include adjustable circuitry. The adjustable circuitry may be adjusted in real time in response to control signals from control circuitry such as a baseband processor or other circuitry (see, e.g., storage and processing circuitry 28 of FIG. 2). The adjustable circuitry may be placed in different states to support different modes of operation. In each mode of operation, the antenna may be tuned to exhibit a different frequency response. By adjusting the antenna to cover different signal frequencies of interest, antenna 40Y can cover a desired range of operating frequencies. Antenna 40Y may, as an example, uses its different frequency response settings to cover substantially the same frequency range as antenna 40N (as an example), even in configurations in which antenna 40Y has been implemented using a more compact (and narrower bandwidth) resonating element.

The adjustable circuitry that is used in tuning antenna 40Y may be coupled between respective portions of antenna resonating element 80, between respective portions of ground 52, or between resonating element 80 and ground 52. As shown in FIG. 5, for example, antenna 40Y may have an adjustable antenna tuning circuit such as adjustable circuit 86 that is coupled between tip portion 84 of antenna resonating element arm 82 in antenna resonating element 80 and antenna ground 52 (i.e., an adjustable circuit having a first terminal coupled to antenna resonating element arm 82 and a second terminal coupled to antenna ground 52). Adjustable circuits such as adjustable circuit 86 may also be incorporated into other portion of antenna 40Y, if desired. The example of FIG. 5 is merely illustrative.

In the FIG. 5 example, adjustable circuit 86 is a switch-based adjustable circuit that includes radio-frequency switch 88. Radio-frequency switch 88 may be adjusted using control signals (e.g., control signals from control circuitry in device 10 that are received via control signal path 102). Other types of control mechanisms may be used, if desired.

Switch 88 may be coupled between arm 84 and ground 52 in series with multiple electrical components such as parallel inductors 96, 98, and 100. Switch 88 may have a terminal such a terminal 104 that is coupled to antenna ground 52. Switch 88 may also have terminals 90, 92, and 94 that are coupled respectively to inductors 96, 98, and 100. Each of inductors 96, 98, and 100 may have a different respective inductance value. When it is desired to couple the inductance of inductor 96 between resonating element arm 82 and antenna ground 52, control signals may be provided to switch 88 (e.g., via control path 102) to couple terminal 104 to terminal 90. When it is desired to couple the inductance of inductor 98 between resonating element arm 82 and antenna ground 52, control signals may be provided to switch 88 to couple terminal 104 to terminal 92. Terminal 104 may be coupled to terminal 94 by switch 88 when it is desired to couple the inductance of inductor 100 between resonating element arm 82 and antenna ground 52.

Antenna 40Y may have any suitable size and shape. In the illustrative example of FIG. 5, antenna 40Y has a length L2 (e.g., a first lateral dimension associated with the length of main resonating element arm 82) and a height H2 (e.g., an orthogonal second lateral dimension associated with the length of short circuit branch 78). The overall area of antenna 40Y in the illustrative configuration of FIG. 5 (e.g., the area associated with antenna resonating element 80) is approximately equal to L2*H2. The volume occupied by antenna 40Y may be L1*H1*T2, where T2 is the thickness of the antenna resonating element. The magnitude of T2 may be comparable to the magnitude of thickness T1 of antenna 40N.

Because of the antenna tuning capabilities provided by adjustable circuit 86, antenna 40Y may, if desired, be implemented in a smaller volume than antenna 40N while exhibiting a comparable bandwidth (i.e., L2*H2 may be less than L1*H1, L2 may be less than L1, and/or L2*H2*T2 may be less than L1*H1*T1). Antennas 40Y and 40N may also be implemented in the same volume (or 40Y may be larger than 40N), in which case antenna 40Y may exhibit a larger bandwidth than antenna 40N.

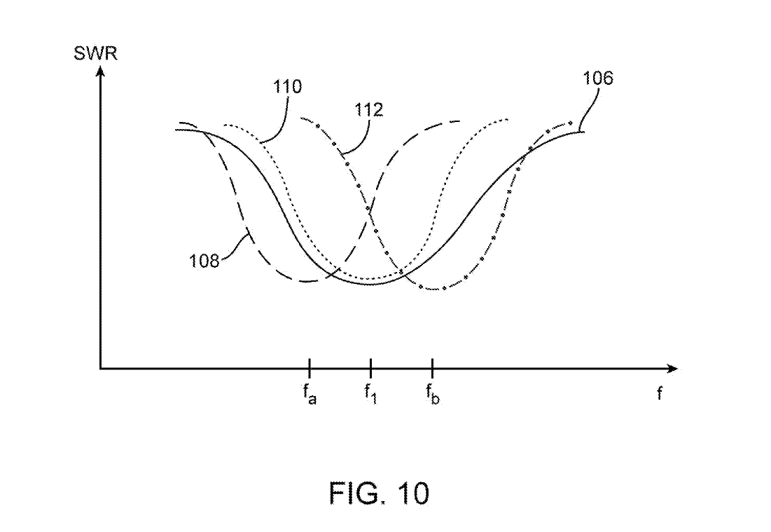

Antenna 40Y of FIG. 5 contains adjustable circuit 86. Adjustable circuit 86 of FIG. 5 is an adjustable inductor based on switch 88 and three associated inductors. The graph of FIG. 10 shows how this type of antenna may be tuned. In FIG. 10, antenna performance (standing wave ratio) has been plotted as a function of frequency. Curve 106 corresponds to the performance of antenna 40N (in this example). Curves 108, 110, and 112 correspond to the performance of antenna 40Y as switch 88 is adjusted between each of its three positions to produce three respective inductance values for adjustable circuit 86. Antenna 40N may exhibit a relatively large bandwidth and may cover the communications band centered at frequency f1, as indicated by curve 106. Curves 108, 110, and 112 may cover narrower frequency ranges (centered, respectively, at fa, f1, and fb). Using tuning, antenna 40Y may be placed into any of three configurations. The overall amount of frequency coverage of antenna 40Y may be comparable to that of antenna 40N due to the ability of antenna 40Y to operate in different tuning states. As this example demonstrates, the resonating structures of antenna 40Y may exhibit a narrower bandwidth than antenna 40N in the absence of tuning, but, using tuning, may be adjusted to cover the same bandwidth as antenna 40N.

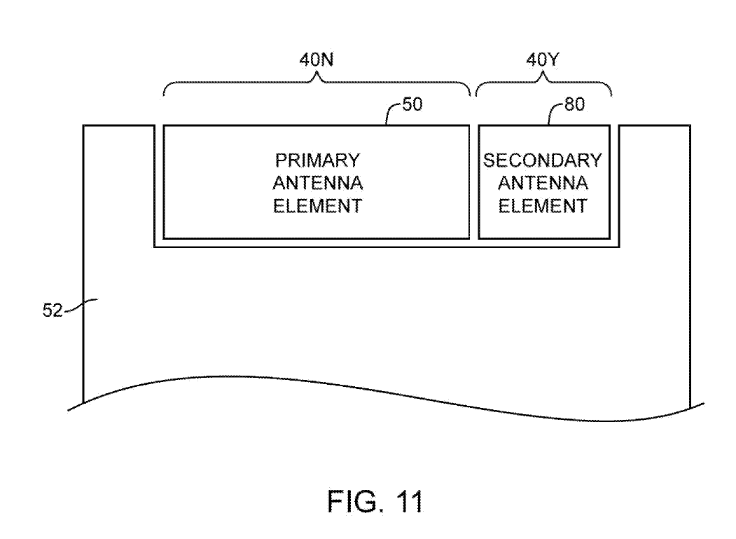

FIG. 11 shows how the size of antenna 40Y may be reduced (taking advantage of its tuning capabilities) so that antenna 40Y is smaller than antenna 40N. As shown in FIG. 11, antenna 40N may be formed from antenna resonating element 50 and antenna ground 52, whereas antenna 40Y may be formed from tunable antenna resonating element 80 and antenna ground 52. Antenna ground 52 may at least partly be formed from a metal device housing for electronic device 10 (as an example) and may be common to both antenna 40N and antenna 40Y. Antenna 40N may be used for transmitting and receiving signals (serving as a primary antenna for device 10). Antenna 40Y may be used exclusively for receiving signals or may be used for transmitting and receiving signals (serving as a secondary antenna for device 10).

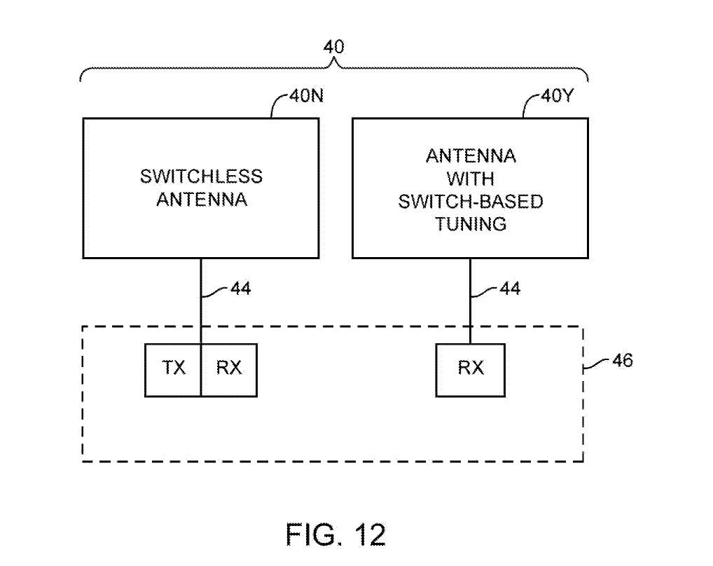

FIG. 12 shows how antenna 40N (i.e., a switchless, non-adjustable antenna) may be coupled to a port of transceiver circuitry 46 that is associated with a transmitter (TX) and a receiver (RX), whereas antenna 40Y (i.e., an antenna with switch-based tuning) may be coupled to a port of transceiver circuitry 46 that is associated with a receiver (RX). In this type of configuration, no transmitter need be associated antenna 40Y. Antenna 40N may be used in transmitting and receiving radio-frequency signals for device 10, whereas in this type of configuration, antenna 40Y may be used exclusively for receiving antenna signals (and not transmitting antenna signals).

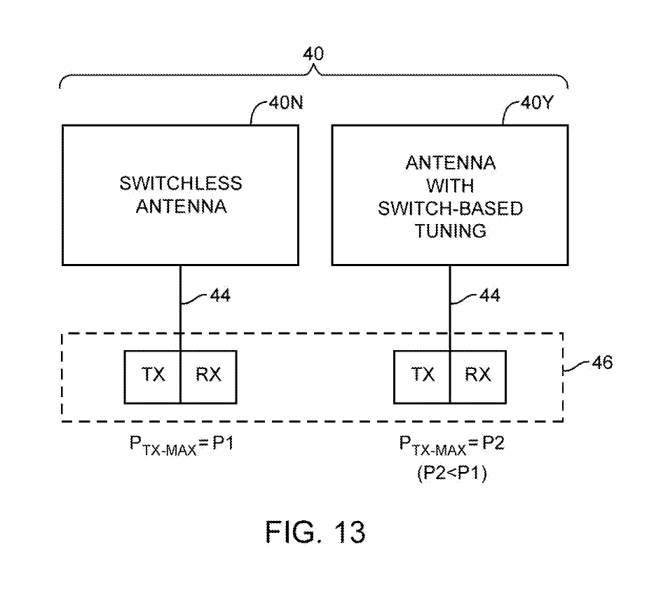

As shown in the illustrative arrangement of FIG. 13, antenna 40N (i.e., a switchless non-tunable antenna) and antenna 40Y (i.e., a tunable antenna that includes switch-based adjustable circuitry 86) may be associated with transceiver circuitry that includes a transmitter (TX) and a receiver (RX) for antenna 40N and a transmitter (TX) and receiver (RX) for antenna 40Y. In this type of configuration both antenna 40N and 40Y may be used in both transmitting and receiving radio-frequency signals. To avoid issues associated with the non-linear behavior of adjustable circuitry 86 in antenna 40Y, the maximum power P_{TX-MAX} that is allowed during signal transmissions using antenna 40Y (i.e., power P2) may be maintained at a lower level than the maximum power P_{TX-MAX} that is allowed during signal transmissions using antenna 40N (i.e., power P1). For example, maximum transmit power P2 may be 70% (or less) of maximum transmit power P1, maximum transmit power P2 may be 30% (or less) of maximum transmit power P1, maximum transmit power P2 may be 15% (or less) of power P1, or maximum transmit power P2 may be 5% (or less) than of power P1 (as examples).

In situations in which use of adjustable circuitry 86 to handle transmitted signal powers is acceptable in some communications bands but not others, control circuitry 28 of device 10 can be used to transmit any desired transmit powers using antenna 40N, while restricting the use of antenna 40Y so that antenna 40Y is only used to transmit signals in a selected acceptable subset of communications bands. If desired, antenna 40Y may be used to transmit signals at different acceptable maximum power levels for different communications bands (e.g., power levels that are lower than those used for antenna 40N in the same bands).

If desired, front-end circuitry (e.g., filters, impedance matching networks, switches, and other circuitry) may be coupled between antennas 40 and transceiver circuitry 46 in FIGS. 11, 12, and 13.

The foregoing is merely illustrative of the principles of this invention and various modifications can be made by those skilled in the art without departing from the scope and spirit of the invention.

What is claimed is:

1. An electronic device, comprising:
radio-frequency transceiver circuitry having a first port with a transmitter and a receiver that are configured to transmit and receive radio-frequency signals and a second port with a receiver that is configured to receive radio-frequency signals;
a switchless antenna coupled to the first port and configured to transmit and receive radio frequency signals; and
a switch-based tunable antenna coupled to the second port and configured to receive radio-frequency antenna signals.

2. The electronic device defined in claim wherein the switchless antenna is larger than the switch-based tunable antenna and wherein the switchless antenna and the switch-based antenna are configured to cover at least one common communications band.

3. The electronic device defined in claim 1 wherein the switchless antenna has a first antenna resonating element and wherein the switch-based antenna has a second antenna resonating element that is smaller than the first antenna resonating element.

4. The electronic device defined in claim 3 wherein the switch-based antenna has an antenna ground and has a switch-based adjustable circuit coupled between the second antenna resonating element and the antenna ground, wherein the switchless antenna is configured to operate in a communications band, and wherein the switch-based antenna is configured to cover the communications band using antenna tuning.

5. The electronic device defined in claim 4 further comprising a conductive housing from which the antenna ground is formed.

6. The electronic device defined in claim 5 wherein the switchless antenna comprises a fixed non-tunable antenna having an antenna ground formed at least partly from the conductive housing and wherein the radio-frequency transceiver circuitry comprises cellular telephone transceiver circuitry that receives radio-frequency signals from the switchless antenna and from the switch-based tunable antenna.

7. The electronic device defined in claim 5 wherein the switch-based adjustable circuit comprises a switchable inductor.

8. The electronic device defined in claim 5 wherein the switch-based adjustable circuit comprises at least one electrical component and a radio-frequency switch coupled between the second antenna resonating element and the antenna ground.

9. The electronic device defined in claim 1 wherein the switchless antenna is configured to serve as a primary antenna that transmits and receives radio-frequency signals for the electronic device.

10. The electronic device defined in claim 9 wherein the switch-based antenna is configured to serve as a secondary antenna that receives radio-frequency signals and that does not transmit radio-frequency signals.

11. The electronic device defined in claim 1 wherein the second port comprises a transmitter that is configured to transmit radio-frequency signals using the switch-based antenna, wherein the radio-frequency transceiver circuitry is configured to transmit radio-frequency signals through the switchless antenna at powers up to a first maximum transmit power and wherein the radio-frequency transceiver circuitry is configured to transmit radio-frequency signals through the switch-based antenna at powers up to a second maximum transmit power that is lower than the first maximum transmit power.

12. An electronic device, comprising:
radio-frequency transceiver circuitry configured to transmit and receive radio-frequency signals;
a non-tunable antenna coupled to the radio-frequency transceiver circuitry that is configured to transmit and receive the radio-frequency signals; and
a tunable antenna coupled to the radio-frequency transceiver circuitry that is configured exclusively for receiving the radio-frequency signals and not transmitting the radio-frequency signals.

13. The electronic device defined in claim 12 further comprising:
a metal housing that serves as an antenna ground for the non-tunable antenna and the tunable antenna.

14. The electronic device defined in claim 13 further comprising a dielectric antenna window in the metal housing that overlaps that non-tunable antenna and the tunable antenna.

15. The electronic device defined in claim 14 wherein the non-tunable antenna comprises a first antenna resonating element, wherein the tunable antenna comprises a second antenna resonating element, and wherein the first antenna resonating element has a maximum lateral dimension larger than the second antenna resonating element.

16. The electronic device defined in claim 12 wherein the non-tunable antenna operates in at least a given communications band and wherein the tunable antenna comprises:
an antenna resonating element;
an antenna ground; and
an adjustable circuit coupled between the antenna resonating element and the antenna ground, wherein the adjustable circuit is operable to tune the tunable antenna to cover the given communications band.

17. The electronic device defined in claim 16 wherein the adjustable circuit includes a radio-frequency switch.

18. The electronic device defined in claim 17 wherein the adjustable circuit includes at least one inductor.

19. A electronic device, comprising:
a conductive housing;
a dielectric antenna window in the conductive housing;
a switchless antenna that is configured to transmit and receive radio-frequency signals through the dielectric antenna window in at least a given communications band; and
a tunable antenna that is configured to receive radio-frequency signals through the dielectric antenna window, wherein the tunable antenna includes an adjustable circuit and wherein the adjustable circuit is operable to tune the tunable antenna to cover the given communications band.

20. The electronic device defined in claim 19 wherein the adjustable circuit includes a radio-frequency switch.

21. The electronic device defined in claim 20 wherein the adjustable circuit includes a component coupled to the switch and wherein the component is selected from the group consisting of: an inductor and a capacitor.

22. The electronic device defined in claim 19 wherein the conductive housing forms an antenna ground for the switchless antenna and the tunable antenna, wherein the tunable antenna comprises a metal resonating element arm that is coupled to the antenna ground using the adjustable circuit, and wherein the adjustable circuit includes at least one radio-frequency switch.
